(19) United States
(12) Patent Application Publication
(10) Pub. No.: US 2007/0146410 A1
(43) Pub. Date: Jun. 28, 2007

(54) IMAGE-FORMING APPARATUS AND IMAGE-FORMING METHOD

(75) Inventors: Masato KAWAKAMI, Ibaraki (JP); Hiromi MOCHIZUKI, Ibaraki (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 11/538,049

(22) Filed: Oct. 2, 2006

(30) Foreign Application Priority Data
Oct. 19, 2005 (JP) 2005-304247

(51) Int. Cl. B41J 2/015

(52) U.S. Cl. 347/21

(57) ABSTRACT

A method for forming an image is provided which forms an image, on a recording medium having no ink-receiving layer such as industrial printing paper sheets, at high image density with uniform image density without feathering of the image. A processing liquid S is discharged from a processing liquid applicator onto a recording medium P before ink droplets I are ejected from printing heads 21-24 onto the recording medium P. The amount of the processing liquid S is controlled so as to allow the processing liquid S to infiltrate entirely before the ink droplet I impacts against the recording medium P. By controlling the amount of the processing liquid S as above, the processing liquid S has infiltrated entirely into the recording medium P when the ink droplet I impacts against the recording medium P. As the result, an image is formed by ideal shape of dots D with high-quality.

### TECHNICAL FIELD

The present invention relates to an image-forming apparatus for forming an image by preliminarily applying a processing liquid onto a recording medium under delivery in a delivery direction, and subsequently ejecting an ink onto the processing liquid-applied recording medium to form an image. The present invention relates also to an image-forming method employing the apparatus.

### BACKGROUND TECHNIQUES

Ink-jet type image-forming apparatuses are widely used which eject ink through an ink-ejecting outlet onto a recording medium (printing medium) such as a paper sheet, a resin film, a cloth, and a metal to form an image. The ink-jet type image-forming apparatus has advantages that an image is formed noiselessly without contact of a printing head with a recording medium at a high printing speed at a high image density, and color printing can be conducted readily.

In industrial printing by use of the ink-jet type image-forming apparatus, a high speed of the printing is required for printing on a large number of recording mediums. For the high-speed printing, a full-line type ink-jet printer is used which has a long printing head, so-called a full-line type printing head, having ink ejection outlets arranged over the entire breadth of the image formation region of the recording medium.

The full-line type ink-jet printer has usually a printing head designed to eject ink droplets perpendicularly onto the recording medium face, and forms (prints) an image on a continuously moved (delivered) recording medium. Thereby the full-line type ink-jet printer is capable of printing at a printing speed higher than a so-called serial type ink-jet printer which forms image by scanning the recording medium with the printing head in the direction across the delivered recording medium.

In the industrial ink-jet type printing, images are formed mostly on plain paper sheets (recording medium having no ink-receiving layer) in view of the running cost. An image printed on a plain paper sheet does not have sufficient water-resistance owing to the absence of the ink-receiving layer. Further, on the plain paper sheet, a color image cannot have simultaneously high print-fastness and high image quality since a high density of the image without ink feathering (running of the ink along the paper fibers) and prevention of bleeding between the colors cannot be achieved simultaneously.

For higher water resistance of the image, inks are used which contain a water-resistant colorant. However, such inks are not sufficient in the water-resistance yet, and tend to clog the nozzles of the printing head owing to the low solubility of the dried ink, which makes the apparatus constitution complicated for prevention of the clogging, disadvantageously.

To solve the above problems, techniques are disclosed which use an ink (recording liquid) containing flocculated particles consisting of water, a colorant and a flocculent for forming high-density images without ink feathering (e.g., Japanese Patent Application Laid-Open No. 10-298469). However, these techniques have problems of nozzle clogging caused by the flocculant in the ink, and insufficient long-term storage.

Further, to solve the above problems, serial type ink-jet printers are disclosed which comprise a liquid-applying means for applying a processing liquid containing a substance for insolubilizing or flocculating the colorant of the ink by scanning the recording medium, and a recording means for forming an image by ejecting the ink containing the colorant on the recording medium (e.g., Japanese Patent Application Laid-Open No. 2000-218772). Such techniques are applicable to serial type ink-jet printers, and employ plural nozzles for applying a processing liquid on a recording medium by scanning the recording medium. Even when a part of the plural nozzles come to clog not to eject the processing liquid, the processing liquid can be applied onto the entire face of the image formation region of the recording medium by scanning with the reciprocating liquid-applying means.

Generally the ink-jet printers are being developed for higher printing speed and for printer size reduction. In a compact printer, in a short time after application of the processing liquid onto the recording medium, the ink is ejected onto the processing liquid-coated portion (coated portion). That is, the ink droplets impact the coated portion of the recording medium before the processing liquid infiltrates completely into the coated portion of the recording medium. In such a case, the ink in a droplet state will coagulate in the processing liquid to cause a so-called “non-spread dotting phenomenon” which is caused by incomplete infiltration of the ink into the recording medium, not giving dots in an ideal dot shape. This phenomenon will be explained later.

### DISCLOSURE OF THE INVENTION

On the above background, the present invention intends to provide an image-forming apparatus for forming an image, on a recording medium having no ink-receiving layer such as industrial printing paper sheets, at high image density with uniform image density without feathering of the image; and an image-forming method employing the image-forming apparatus.

The image-forming apparatus of the present invention, for achieving the above object, has a processing liquid applicator for applying a processing liquid onto a recording medium under delivery in a delivery direction, and a printing head for ejecting ink onto the recording medium on which the processing liquid has been applied thereon by the processing liquid applicator:
(1) the image-forming apparatus comprising a controlling means for controlling the amount of the processing liquid to be applied to the recording medium being delivered depending on the delivery speed of the recording medium in the delivery direction.
(2) The controlling means may control the amount of the processing liquid to allow the processing liquid to infiltrate entirely into the recording medium before the ink is ejected from the printing head onto the portion of the recording medium on which the processing liquid has been applied by the processing liquid applicator.
(3) The controlling means may serve to decrease the amount of the processing liquid for a high-speed delivery of the recording medium and to increase the amount of the processing liquid for a low speed delivery of the recording medium to allow the processing liquid to infiltrate entirely into the recording medium before the ink is ejected from the printing head onto the portion of the recording medium on which the processing liquid has been applied by the processing liquid applicator.
(4) The processing liquid applicator may have plural nozzles which discharge respectively the processing liquid in accordance with an electric pulse, and
(5) the controlling means may the electric pulse to control the amount of the processing liquid ejected from the processing liquid applicator.
(6) The controlling means may control the amount of the processing liquid by selecting the nozzle or nozzles out of the plural nozzles for ejecting the processing liquid.
(7) The processing liquid applicator may have the same level of resolution as the printing head, and
(8) the time interval may be not more than 10 seconds between application of the processing liquid by the processing liquid applicator and ejection of the ink from the printing head onto the portion of the recording medium on which the processing liquid has been applied.

The image-forming method of the present invention, for achieving the above object, for forming an image by applying a processing liquid onto a recording medium under delivery in a delivery direction, and subsequently ejecting ink onto the recording medium on which the processing liquid has been applied, wherein
(9) the amount of the processing liquid to be applied to the recording medium under delivery is controlled depending on the delivery speed of the recording medium in the delivery direction.
(10) the amount of the processing liquid may be controlled so as to allow the processing liquid to infiltrate entirely into the recording medium before the ink is ejected onto the portion of the recording medium on which the processing liquid has been applied.
(11) The amount of the processing liquid may be decreased for a high-speed delivery of the recording medium and the amount of the processing liquid may be increased for a low speed delivery of the recording medium to allow the processing liquid to infiltrate entirely into the recording medium before the ink is ejected from the printing head onto the portion of the recording medium on which the processing liquid having been applied.
(12) The processing liquid may be ejected from an applicator having the same level of resolution as the printing head, and
(13) the time interval may be not more than 10 seconds between application of the processing liquid by the processing liquid applicator and ejection of the ink from the printing head onto the portion of the recording medium on which the processing liquid has been applied.

Here, the “processing liquid” is a solution for preliminary treatment for insolubilizing or flocculating a colorant of the ink ejected from the printing head.

The processing liquid employed in the present invention is explained below. The processing liquid employed in the present invention contains at least a cationic substance. The cationic substance may be (1) a low-molecular cationic substance, or (2) a high-molecular cationic substance; more preferably the cationic substance is (3) a cationic substance having at least one molecular weight distribution peak respectively in the region of molecular weight of not more than 1,000 and in the region of molecular weight from 1,500 to 10,000 as measured by GPC.

The above low-molecular cationic compound (1) includes specifically salts of primary, secondary and tertiary amines such as hydrochloride salts and acetate salts of dodecylamine, coconut-amine, stearylamine, and rosin-amine; quaternary ammonium salts such as dodecyltrimethylammonium chloride, dodecylbenzyltrimethylammonium chloride, dodecyldimethylbenzylammonium chloride, stearyltrimethylammonium chloride, benzyltributylammonium chloride, benzalconium chloride, and cetyltrimethylammonium chloride; pyridinium salts such as cetylpyridinium chloride, and cetylpyridinium bromide; imidazoline type cationic compounds such as 2-heptadecenyl-hydoxyethylimidazoline; and ethylene oxide adducts of higher alkylamines such as dihydroxyethylstearylamine.

In the present invention further, ampholytic surfactants are useful which become cationic in a certain pH region. Specifically, the ampholytic surfactants include carboxylate salt type, sulfate ester type, sulfonic acid type, phosphate ester type of ampholytic surfactants: the carboxylate salt type ampholytic surfactants include specifically amino acid type ampholytic surfactants; R—NH—CH₂—CH₂—COOH type compounds; betaine type compounds such as stearyldimethylbetaine, and dodecyldihydroxyethylbetaine. Naturally, in use of the ampholytic surfactant, the processing liquid is adjusted to be at a pH not higher than the isoelectric point, or to have a pH not higher than the isoelectric point on mixing with an ink on a recording medium. Although the low-molecular cationic compounds are shown above as the examples, the compounds are not limited thereto in the present invention, naturally.

The above high-molecular cationic compounds (2) include specifically polyallylamine, polyamine sulfone, polyvinylamine, chitosan, and entirely or partially neutralized products thereof with an acid such as hydrochloric acid and acetic acid, but are not limited thereto.

In the present invention, the above high-molecular cationic compound may be a partially cationized high-molecular nonionic compound, exemplified by a copolymer of vinylpyrrolidone and a quaternary aminoalkyl alkylate salt, and a copolymer of acrylamide and a quaternary aminomethylacrylamide salt, but is not limited thereto naturally. The high-molecular substance or cationic high-molecular substance is preferably water-soluble, but may be in a state of dispersion such as a latex and an emulsion.

The cationic compound (3) mentioned above is explained below specifically. The cationic compound having the molecular weight distribution peak in the region of molecular weight of not more than 1,000 may be selected suitably from the above-mentioned low-molecular cationic compounds (1). In the present invention, the cationic compound having the molecular weight distribution peak in the region of molecular weight of not more than 1,000 may be selected from many compounds having nearly a monodisperse molecular weight distribution. A simple compound having no molecular weight distribution is considered to have its molecular weight distribution peak at the position of the molecular weight corresponding to the chemical formula.

The cationic compound having the molecular weight distribution peak in the region of the molecular weight from 1,500 to 10,000 may be selected suitably from the above-mentioned high-molecular cationic compounds (2). The cationic compound having the molecular weight distribution peak in the region of molecular weight from 1,500 to 10,000 such as high-molecular polyallylamine gives the effects mentioned above. That is, in the second step of the reaction of the processing liquid and the ink, the high-molecular cationic compound adsorbs the association product of an anionic compound in the dye or pigment ink and the low-molecular cationic compound, or a pigment flocculate to enlarge the size thereof to cause solid-liquid separation and to retard penetration of the dye or pigment of the ink into the interstice of the fibers of the recording medium, whereby the isolated liquid portion only is allowed to infiltrate into the recording medium to achieve simultaneously high-quality and high fixability of the printing. In this process, the high-molecular cationic compound having at least one molecular weight distribution peak in the region of molecular weight from 1,500 to 10,000 can achieve the above effect of the present invention. The cationic compound is contained in the processing liquid in an amount ranging from 1 to 10 wt %, preferably from 1 to 5 wt %.

The ink useful in the present invention includes direct dyes, acid dyes, food dyes, basic dyes, reactive dyes, disperse dyes, vat dyes, soluble vat dyes, reactive disperse dyes, oil dyes, and pigments. For safety, aqueous dyes are preferred. For weatherability, aqueous pigment inks are preferred. The content of the recording agent is decided depending on the kind of the liquid medium, and characteristics required for the ink. The content ranges generally from 0.2 to 20 wt %, preferably from 0.5 to 10 wt %, more preferably from 1 to 5 wt %. The organic solvent useful in the present invention includes amides such as dimethylformamide, and dimethylacetamide; ketones and ketoalcohols such as acetone, and diacetone alcohol; ethers such as tetrahydrofuran, and dioxane; oxyethylene or oxypropylene addition polymers such as diethylene glycol, triethylene glycol, tetraethylene glycol, dipropylene glycol, tripropylene glycol, polyethylene glycol, and polypropylene glycol; alkylene glycols such as ethylene glycol, propylene glycol, trimethylene glycol, butylenes glycol, 1,2,6-hexanetriol, and hexylene glycol; thiodiglycol; glycerin; lower alkyl ethers of polyhydric alcohols such as ethylene glycol monomethyl (or monoethyl) ether, diethylene glycol monomethyl (or monoethyl) ether, and triethylene glycol monomethyl (or monoethyl) ether; di-(lower alkyl) ethers of polyhydric alcohols such as triethylene glycol dimethyl (or diethyl) ether, and tetraethylene glycol dimethyl (or diethyl) ether; sulfolane; N-methyl-2-pyrrolidone; and 1,3-dimethyl -2-imidazolidinone. The above-mentioned organic solvent is contained in the ink at a content ranging generally from 1 to 50 wt %, preferably from 2 to 30 wt % based on the total weight of the ink. The above organic solvent may be used singly or as a mixture of two or more thereof. A preferred composition of the liquid medium is composed of water and one or more organic solvents, the organic solvent or solvents containing at least one water-soluble high-boiling solvent such as a polyhydric alcohol like diethylene glycol, triethylene glycol, or glycerin. The liquid medium may contain a resin, a neutralizing agent, or the like for dispersing the pigment.

### BRIEF DESCRIPTION OF THE DRAWINGS

FIG. 1 is a side view illustrating schematically constitution of a printer as an example of the image-forming apparatus of the present invention.

FIG. 2 is a perspective view of the printer of FIG. 1.

FIG. 3 is a block diagram showing a control system of the printer.

FIGS. 4(a-1-1 ) to FIGS. 4(b-2) illustrate schematically states of a processing liquid applied on a recording medium and ink ejected thereon. FIGS. 4(a-1-1) to 4(a-1-3) are sectional views showing schematically the states of infiltration of a processing liquid and infiltration of ink deposited thereon. FIG. 4(a-2) is a plan view of the recording medium after deposition of the ejected ink droplets on the recording medium. FIGS. 4(b-1-1) to 4(b-1-3) show a comparative example, illustrating state of deposition of ejected ink droplet before the processing liquid infiltrates completely into the recording medium. FIG. 4(b-2) is a plan view of the recording medium after deposition of the ejected ink droplets on the recording medium.

FIGS. 5(1) to 5(4) illustrate schematically states in printing in which the amount of the processing liquid is decreased in high-speed printing.

FIG. 6 is a flow chart showing steps of controlling the amount of the processing liquid.

FIG. 7(a) illustrates schematically a print state at 75% duty relative to 100% duty for a low delivery speed of the recording medium; FIG. 7(b) that at 50% duty; and FIG. 7(c) that at 25% duty.

FIG. 8 is a graph showing dependence of the application amount of the processing liquid on the delivery speed of the recording medium in the case where the processing liquid is applied by a liquid sprayer.

FIG. 9 is a graph showing dependence of the duty of the processing liquid on the delivery speed of the recording medium in the case where the resolution of the processing liquid applicator and the resolution of the printing head are booth 600 dpi.

FIG. 10 is a graph showing dependence of the duty of the processing liquid on the delivery speed of the recording medium in the case where the resolution of the processing liquid applicator and the resolution of the printing head are booth 300 dpi.

FIG. 11 is a plan view illustrating schematically another example different in number and arrangement of the processing liquid applicators and the printing heads.

FIG. 12 is a plan view illustrating schematically still another example different in number and arrangement of the processing liquid applicators and the printing heads.

FIG. 13 is a plan view illustrating schematically still another example different in number and arrangement of the processing liquid applicators and the printing heads.

### BEST MODE FOR CARRYING OUT THE INVENTION

The present invention has been made practical in a printer which forms an image on a recording medium after application of a processing liquid for insolubilizing a colorant in the ink on the recording medium like a corrugated paper board.

### EXAMPLE 1

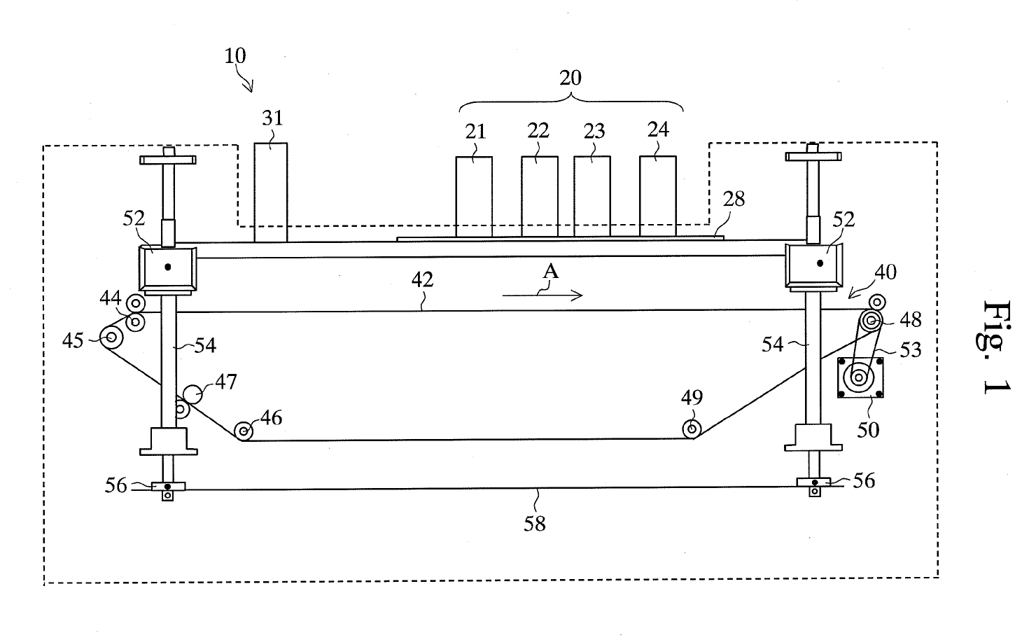

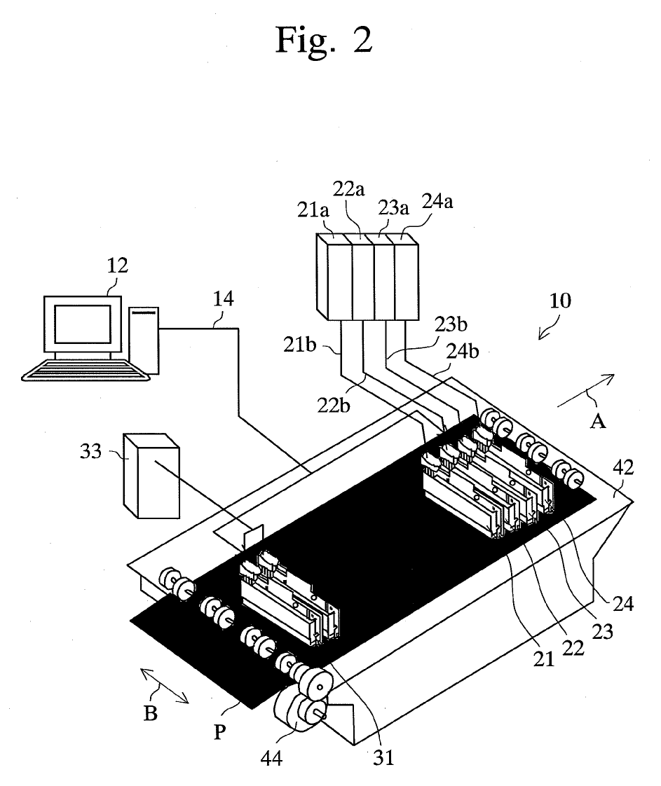

An image-forming apparatus of the present invention is explained below by reference to FIGS. 1 and 2.

FIG. 1 is a side view illustrating schematically constitution of a printer as an example of the image-forming apparatus of the present invention. FIG. 2 is a perspective view of the printer shown in FIG. 1.

The printer 10 comprises a printing head unit 20 having printing heads 21,22,23,24 for ejection of ink to form an image on a recording medium P like a corrugated paper board; a processing liquid-applicator 31 for applying a processing liquid on the recording medium P; and a delivery unit 40 or delivering the recording medium P in the arrow-A direction (recording medium delivery direction). The printing head 21 ejects a black ink, the printing head 22 ejects a cyan ink, the printing head 23 ejects a magenta ink, and the printing head 24 ejects a yellow ink. The printing head unit 20 is equipped with a head-moving motor (not shown in the drawing) for moving the printing heads 21-24 respectively to positions for capping, printing, and wiping; wiper blades for wiping a dust or a remaining liquid drop off from ink-ejection faces of the printing heads 21-24; and capping mechanisms for capping the printing heads 21-24. The printing head unit 20 is fixed to a flat engine base 28, and is movable vertically together with this engine base 28.

The delivery unit 40 has four delivery belts 42 which allow the recording medium to pass below the printing head unit 20. The delivery belts 42 are held by driven rollers 44,45,46 and an encoder roller 47, and driving roller 48. The delivery belts 42 are tensioned by a tensioner 49. A driving motor 50 drives a timing belt 53 to rotate the driving roller 48, and the driving roller drives the delivery belt 42 to turn around in the recording medium delivery direction (arrow-A direction).

The engine base 28 holding the printing head unit 20 is rectangular, and is fixed at its four corners to nuts 52. The nuts 52 are engaged with the screwed shafts 54 and are moved vertically by rotation of the screwed shaft 54. The four screwed shafts 54 (only two of the shafts are shown in the drawing) are respectively connected to a sprocket 56 at the lower end portions. The four sprockets 56 are linked by a chain 58. The screwed shafts 54 are rotated synchronously by driving the chain 58 by a driving motor (not shown in the drawing). Thereby the head unit 20 together with the engine base 28 is moved vertically.

The printing heads 21,22,23,24, the processing liquid applicator 31, and the delivery unit 40 of the printer 10 are connected through a USB cable 14 to an information-processing unit 12 as shown in FIG. 2. Thereby printing data, commands for start or finish of the operation, and other information are transmitted to the printing heads 21 and other units. The information processing unit 12 and the delivery unit 40 exchange signals, through the USB cable 14, for heading of the recording medium P and signals for synchronization of delivery rate and the printing.

The processing liquid applicator 31 is placed with its length side perpendicular to the recording medium delivery direction (across the paper sheet in the breadth direction: arrow-B direction) and applies the processing liquid onto the recording medium P. The processing liquid is applied uniformly on the recording medium P by the processing liquid-applicator 31. A high-quality image can be formed by ejecting ink on the recording medium P on which the processing liquid has been uniformly applied by the processing liquid-applicator. The processing liquid-applicator may be provided in plurality. When two or more processing liquid-applicators are provided, the applicators may be placed successively in the recording medium delivery direction. The processing liquid applicator 31 is connected to a processing liquid tank 33 holding the processing liquid. The processing liquid applicator 31 is of an ink-jet type and applies the processing liquid on the recording medium by ejection of the liquid in droplets. Therefore, the amount of the liquid application can readily be controlled, and the region of the application can be limited to the image-formation region (print area).

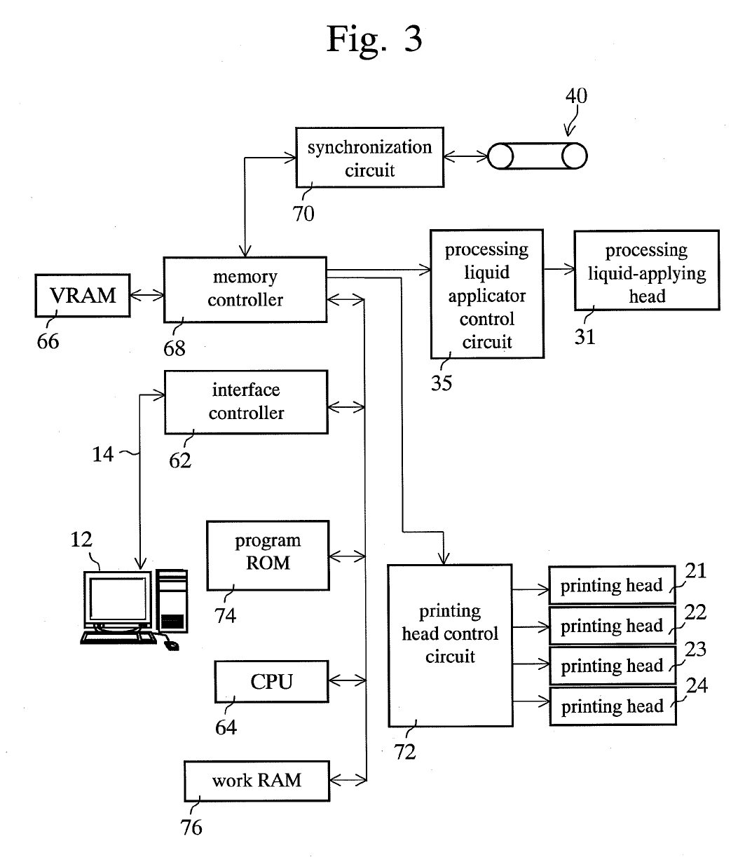

The width of the area on which the processing liquid is applied by the processing liquid applicator 31 on the recording medium P is larger than the width of the area of ink dotting by the printing heads 21,22,23,24 on the recording medium P. Therefore, all of the ink droplets ejected from the printing heads 21,22,23,24 deposit within the processing liquid-applied area on the recording medium P to form a high-quality image. In this example, the resolution of the processing liquid applicator 31 of the ink-jet system is the same as that of the printing heads 21,22,23,24. However, the resolutions may be made different. Incidentally, the processing liquid-applicator 31 is controlled by a control circuit 35 (FIG. 3) as described later.

The printing heads 21,22,23,24 are respectively connected through tubes 21b,22b,23b,24b to ink tanks 21a,22a,23a,24a. Inks are fed respectively from the ink tanks 21a,22a,23a,24a to the printing heads 21,22,23,24. The printing heads 21,22,23,24, when not working for image formation, are capped by a capping mechanism (not shown in the drawing) to prevent drying, clogging, or like inconveniences. Further a sucking mechanism (not shown in the drawing) for sucking the recording medium P like thick card boards by a vacuum pump may be provided below the recording medium stage (not shown in the drawing) for delivery of the recording medium P.

The control system of the printer 10 is explained below by reference to FIG. 3.

FIG. 3 is a block diagram showing a control system of the printer. In FIG. 3 the same numerals are used as in FIGS. 1 and 2 for denoting the corresponding constitutional elements.

Printing data (recording data) are transmitted from the information processing unit 12 through a USB cable 14 to an interface controller 62. A CPU 64 analyzes the command transmitted from the USB interface, and gives indication to VRAM 66 for bitmap development of image data for respective color components of the recording data. According to this indication, a memory controller 68 writes the image data transmitted from the interface controller 62 to the VRAM 66 at a high speed. Simultaneously with this writing, the application region and application amount of the processing liquid corresponding to the image data for the respective colors are read, and gives indication to the VRAM 66 for bitmap development. According to the indication, the memory controller 68 writes the image data received from the interface controller 62 to the VRAM 66 at a high speed.

The delivery unit 40 transmits, to a synchronization circuit 70, a top of medium signal, which is generated when a front end of a recording medium P is detected and a positional pulse signal in synchronization with the movement of the recording medium P. The synchronization circuit 70 synchronizes the received, a top of medium signal and positional pulse signal by a system clock (not shown in the drawing). In synchronization with the positional pulse, the data in the VRAM 66 is read out by a memory controller 68 at a high speed, and the read-out data is transmitted through the processing liquid applicator controlling circuit 35 (an example of the controlling means in the present invention) to the processing liquid applicator 31. The processing liquid applicator 31 discharges the processing liquid in accordance with the transmitted data. That is, the processing liquid applicator 31 discharges the processing liquid under control by the processing liquid applicator-controlling circuit 35.

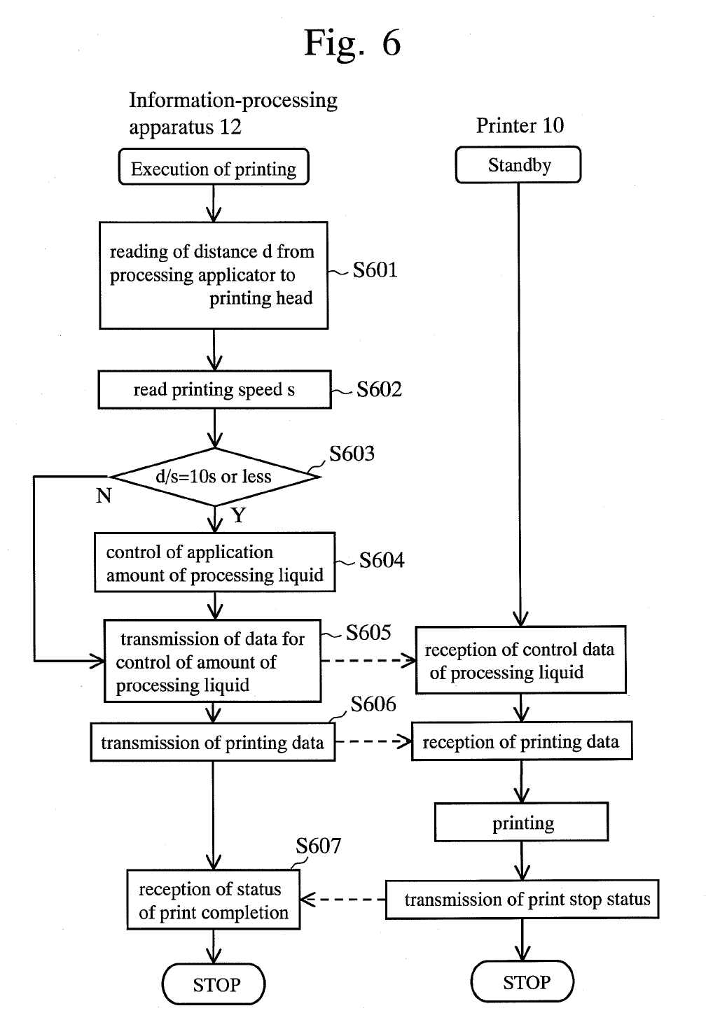

On the other hand, the data read out by the memory controller 68 is transmitted through a printing head control circuit 72 to printing heads 21-24. The printing heads 21-24 eject ink onto the recording medium P in accordance with the transmitted data to form an image on the recording medium P. Incidentally, the CPU 64 works in synchronization with the positional pulse signal according to the processing program memorized in a program ROM 74. This processing program corresponds, for example, to the steps shown in FIG. 6 as a flow chart. The CPU 64 utilizes the work RAM 76 as a working memory.

As described above, the processing liquid applicator 31 ejects a processing liquid under control by the processing liquid applicator control circuit 35. This processing liquid applicator control circuit 35 controls the amount of the processing liquid discharged from the processing liquid applicator 31 depending on the delivery speed of the recording medium P delivered in the delivery direction (the arrow-A direction in FIGS. 1 and 2). The processing liquid applicator control circuit 35 controls the amount of application of the processing liquid so that the processing liquid may infiltrate entirely into the recording medium P in the portion on which the processing liquid is applied, before the ink is ejected thereon from the printing head 21-24. Specifically, the amount of application of the processing liquid is controlled by the processing liquid applicator control circuit 35 to allow the processing liquid applied onto the recording portion of the recording medium P to infiltrate entirely into the recording medium P before the ink is ejected thereon from the printing heads 21-24: the amount of the processing liquid is decreased for a higher delivery speed of the recording medium P, whereas the amount thereof is increased for a lower delivery speed.

The processing liquid applicator 31 has the same construction as the printing heads 21-24, having plural nozzles for ejecting the processing liquids. The nozzles have respectively a heater (not shown in the drawing) which is controlled (turned on and off) by the processing liquid applicator control circuit 35. The processing liquid is ejected by the heat generated by the heater. The processing liquid applicator control circuit 35 can control independently the heaters of the nozzles. Therefore, the processing liquid applicator control circuit 35 can control the processing liquid applicator 31 to allow the processing liquid from only a selected nozzle out of the plural nozzles. By such control, the amount of application of the processing liquid ejected from the processing liquid applicator 31 can be controlled.

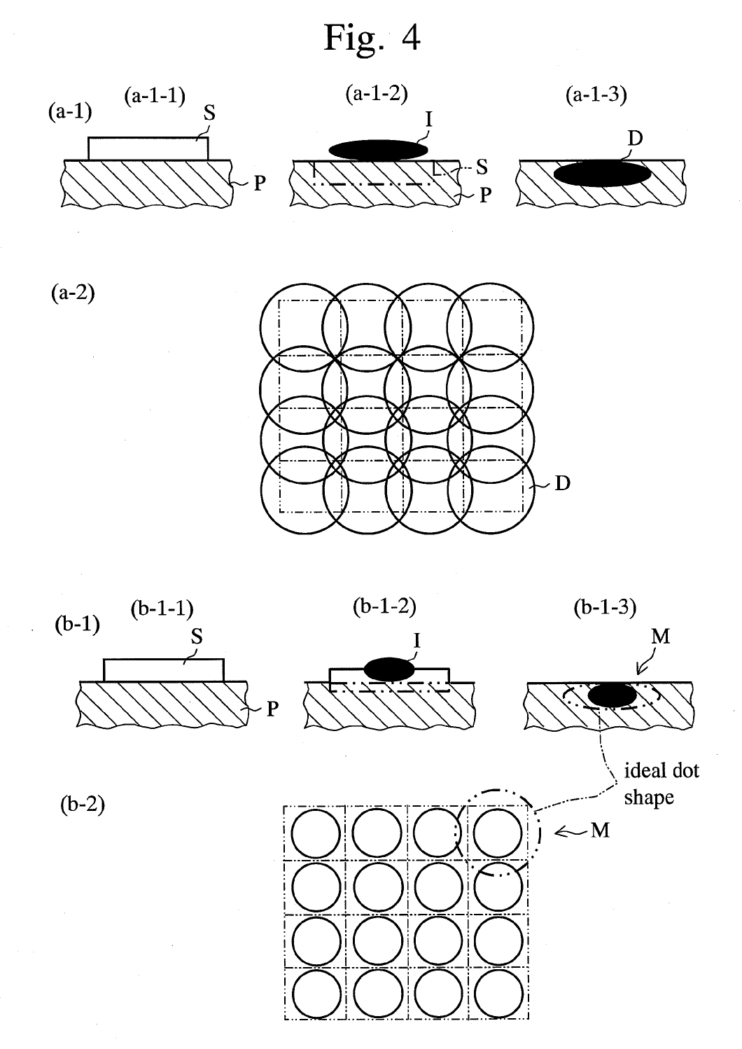

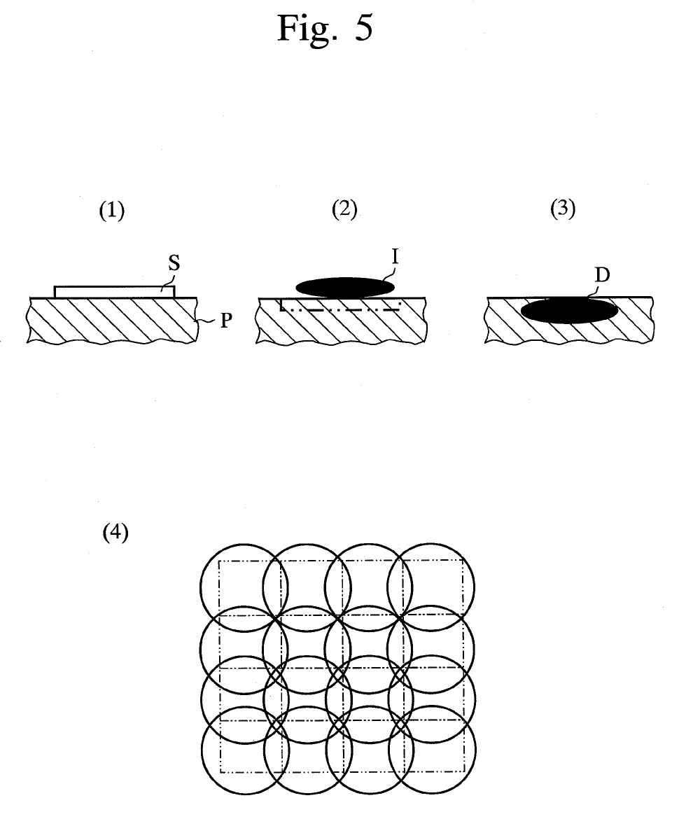

The effect of the control of the amount of application of the processing liquid is explained by reference to FIGS. 4(a-1-1) to FIG. 4(b-2) and FIGS. 5(1) to 5(4).

FIGS. 4(a-1-1) to 4(b-2) illustrate schematically the behavior of a processing liquid applied on a recording medium and an ink ejected thereon. FIGS. 4(a-1-1) to 4(a-1-3) are sectional views showing schematically infiltration of a processing liquid and infiltration of an ink deposited thereon. FIG. 4(a-2) is a plan view of the recording medium after deposition of the ejected ink droplets on the recording medium. FIGS. 4(b-1-1) to 4(b-1-3) show a comparative example, illustrating the states of deposition of an ejected ink droplet before the processing liquid infiltrates entirely into the recording medium. FIG. 4(b-2) is a plan view of the recording medium shown in FIG. 4(a-1-3) after deposition of the ejected ink droplets on the recording medium. FIGS. 5(1) to 5(4) illustrate schematically states in which the amount of the processing liquid is decreased in high-speed printing.

In the cases shown in FIG. 4(a-1-1) and FIG. 4(b-1-1), the processing liquid S is applied in the same amount (in the same thickness) on the recording mediums. Here, the term “liquid application” signifies discharge of the processing liquid on the recording medium P through all of the nozzles of the processing liquid applicator 35 (FIG. 1, etc.) capable of ejecting selectively the processing liquid in the same manner as the ink-jet system.

FIGS. 4(a-1-1) to 4(a-1-3) and FIG. 4(a-2) show the states in the cases in which the delivery speed of the recording medium P is low. In these cases, as shown in FIG. 4(a-1-1), the processing liquid S is applied by a processing liquid applicator 35 (FIG. 1, etc.) onto the recording medium P: the applied processing liquid S entirely infiltrates before the ink droplet I impact against the recording medium P since the delivery speed of the recording medium is low. That is, the processing liquid S has entirely infiltrated into the recording medium P before the ink droplet I impacts against the recording medium P. As the result, an ink dot D is formed in an ideal dot shape on the recording medium P as shown in FIG. 4(a-1-3) to form a high-quality image as shown in FIG. 4(a-2).

On the other hand, in the case where the delivery speed of the recording medium P is high, as shown in FIGS. 4(b-1-1) to 4(b-1-3) and FIG. 4(b-2), the processing liquid S is applied from a processing liquid applicator 35 (FIG. 1, etc.) on the recording medium P similarly as above before the ejection of ink droplet I through the printing heads 21-24 on to the recording medium P. In this case, since the delivery speed of the recording medium P is high, the applied processing liquid S has not entirely infiltrated at the time of impact of the ink droplet I against the recording medium as shown in FIG. 4(b-1-2). That is, the processing liquid S does not entirely infiltrate into the recording medium P before the ink droplet I impacts against the recording medium P. As the result, an ink dot D formed does not have an ideal dot shape on the recording medium P as shown in FIG. 4(b-1-3) to cause a so-called “non-spread dotting phenomenon M” as shown in FIG. 4(b-2).

Even in the case where the delivery speed of the recording medium P is the same as that corresponding to FIGS. 4(b-1-1) to 4(b-1-3), the “non-spread dotting phenomenon” can be prevented by decreasing the amount of the processing liquid S applied from the processing liquid applicator 31 (FIG. 1, etc.) on the recording medium P as shown in FIGS. 5(1) to 5(4). The processing liquid S is ejected from the processing liquid applicator 31 (FIG. 1, etc.) onto the recording medium P as shown in FIG. 5(1), before an ink droplet I is ejected from the printing heads 21-24. In this case, the amount of the processing liquid S is adjusted so as to complete the infiltration into the recording medium P as shown in FIG. 5(2) before the ink droplet I impacts the recording medium P. As the result of the control of the amount of the processing liquid S, the processing liquid infiltrates entirely into the recording medium P before the ink droplet I impacts against the recording medium P. Thereby, the dot is formed in an ideal dot shape D for formation of an image as shown in FIG. 5(3) to form a high-quality image as shown in FIG. 5(4).

A method for controlling the application amount of the processing liquid as above is explained by reference to FIG. 6. FIG. 6 is a flow chart of an example of the method of controlling the application amount of the processing liquid. The criterion for the speed of the delivery (or the printing speed) of the recording medium P (FIG. 4, etc.) is whether the time is 10 seconds or less between application of the processing liquid by the processing liquid applicator 31 and ejection of the ink by the printing head 21-24 (FIG. 1) (namely, the time between impact of the processing liquid and impact of the ink against the recording medium P).

In the flow chart of FIG. 6, the flow is started before a printing data is transmitted from an information processing apparatus 12 (FIG. 3) through an USB cable 14 to an interface controller 62. The flow is started when the user presses a printing button or when indication is transmitted from the information processing unit 12 (FIG. 3), or a like timing.

The information processing unit 12 reads, before transmission of a printing data to the interface controller 62, the distance d (m) between the processing liquid applicator 31 and the printing head 21 (S601), and the distance d is memorized in the printing unit 10 preliminarily. Next, the information processing unit 12 reads the delivery speed (printing speed) s (m/s) (S602). Then the time d/s (seconds) is calculated for delivery of the recording medium P from the processing liquid applicator 31 to the printing head 21, and the time is judged whether it is 10 second or less, or not (S603). The portion of the recording medium P having passed the position of the processing liquid applicator 31 (FIG. 1, etc.) contains the processing liquid applied thereon. At the instant when this portion reaches the position of the printing head 21, ink is ejected onto this portion.

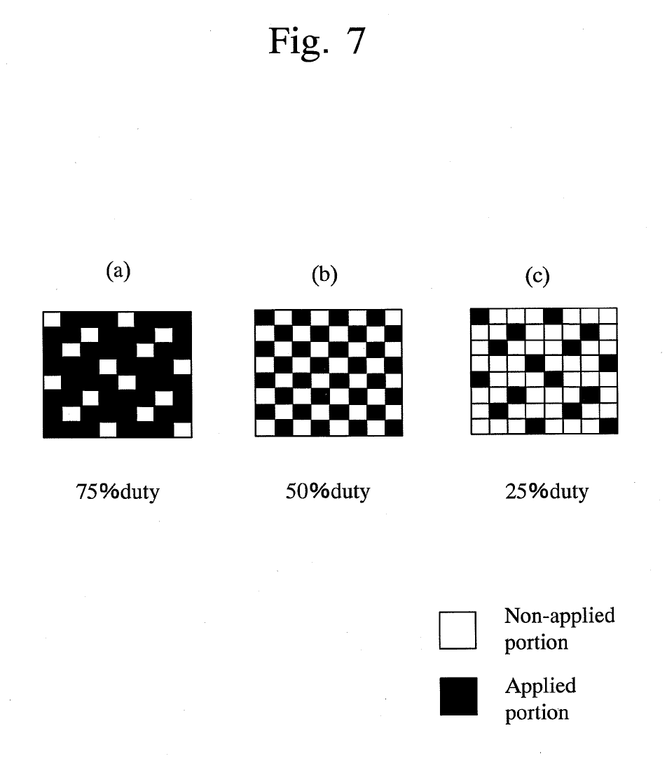

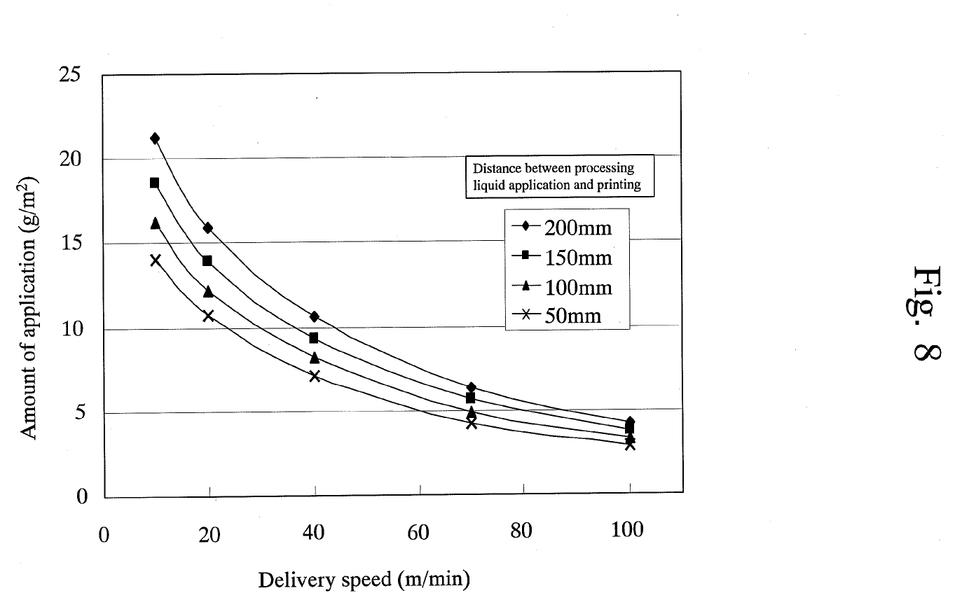

When the above time is 10 second or less, the delivery speed is higher, and the amount of the processing liquid ejected from the processing liquid applicator 31 onto a portion of the recording medium P is controlled (adjusted) to allow the entire of the processing liquid to infiltrate into the recording medium of this portion before the ink is ejected from the printing head 21 (S604). That is, the thickness of the processing liquid applied on the recording medium P is adjusted. The control of the amount of the processing liquid depending on the recording medium delivery speed is described later by reference to FIGS. 8-10. Further, the method of control of the processing liquid is described later by reference to FIGS. 7(a)-7(c).

The amount of the processing liquid having been adjusted in the step S604 is transmitted to the processing liquid applicator control circuit 35 (FIG. 3) of the printer (S605). On the other hand, when the above time is more than 10 second as judged in the step S603, the delivery speed of the recording medium P is lower, and the processing liquid discharged from the processing liquid applicator 31 onto a portion of the recording medium P will infiltrate entirely into the recording medium of this portion before the ink is ejected from the printing head 21. Therefore the amount of the processing liquid need not be controlled, and the operation proceeds to the next step S605. Thereafter, printing data is transmitted from the information processing unit 12 to the printer 10 (S606). The printer 10 conducts printing in accordance with the printing data. After the printing operation is completed, print-finish status is transmitted to the information processing unit 12. After receiving the printing finish status from the printer 10 (S609), the information processing unit 12 finishes this flow.

In the above embodiment, the amount of the processing liquid is controlled by the information processing unit 12. However, the control may be conducted by preliminarily inputting a control pattern to a program ROM 74 or the like of the printer 10. For high-speed printing (with a high-speed delivery of the recording medium), the control is preferably conducted by the printer 10.

The control of the amount of the processing liquid to be discharged from the processing liquid applicator 31 is explained by reference to FIGS. 7(a) to 7(c).

FIG. 7(a) illustrates schematically a print state at a 75% duty (an amount of the liquid relative to 100%-coverage with the processing liquid in the case where the delivery speed of the recording medium is low); FIG. 7(b) illustrates schematically a print state of 50% duty; and FIG. 7(c) illustrates schematically a print state of 25% duty. Here, the term “duty” of the processing liquid signifies the value of [(the number of ejected dots)/(vertical resolution×lateral resolution)]×100%. The “case where the delivery speed of the recording medium is low” signifies a case where the delivery time is judged to be longer than 10 seconds in the flow of S603 in FIG. 6.

As described above, the processing liquid applicator 31 (FIG. 1, etc.) has an ink-jet type structure, and has plural nozzles for ejecting the processing liquid. The plural nozzles have respectively a heater (not shown in the drawing) controlled (turned on and off) by the processing liquid applicator control circuit 35 (FIG. 3). The processing liquid is ejected by heating with the heater. The processing liquid applicator control circuit 35 controls the heaters of the nozzles separately. That is, the processing liquid applicator control circuit 35 controls the processing liquid applicator 31 to allow suitable nozzles (selected nozzles) of the plural nozzles to eject the processing liquid, thereby controlling the amount of the processing liquid ejected from the processing liquid ejected from the processing liquid applicator 31.

The heaters attached to the respective nozzles of the processing liquid applicator 31 are selectively allowed to generate heat according to processing liquid application control data (FIG. 6). For 75% duty, the processing liquid is ejected from 75% of the entire nozzles as shown in FIG. 7(a); for 50% duty, the processing liquid is ejected from 50% of the entire nozzles as shown in FIG. 7(b); and for 25% duty, the processing liquid is ejected from 25% of the entire nozzles as shown in FIG. 7(c). In such a manner, an intended amount of the processing liquid is applied by selecting the nozzles corresponding to the amount of the processing liquid to be ejected from the processing liquid applicator 31. As the result, the ink droplets impact the portion of the recording medium P after the processing liquid has infiltrated into the recording medium. Therefore, images are formed without irregularity in the image density at a high image density without ink running even on a recording medium having no ink-receiving layer.

The relation between the recording medium sheet delivery speed and the amount of application of the processing liquid is explained by reference to FIGS. 8-10.

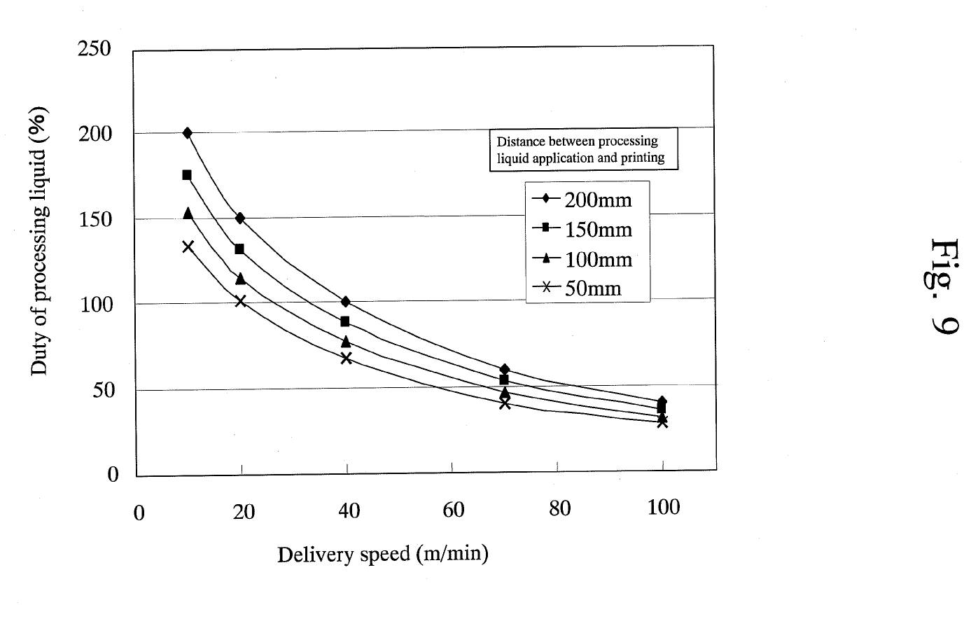

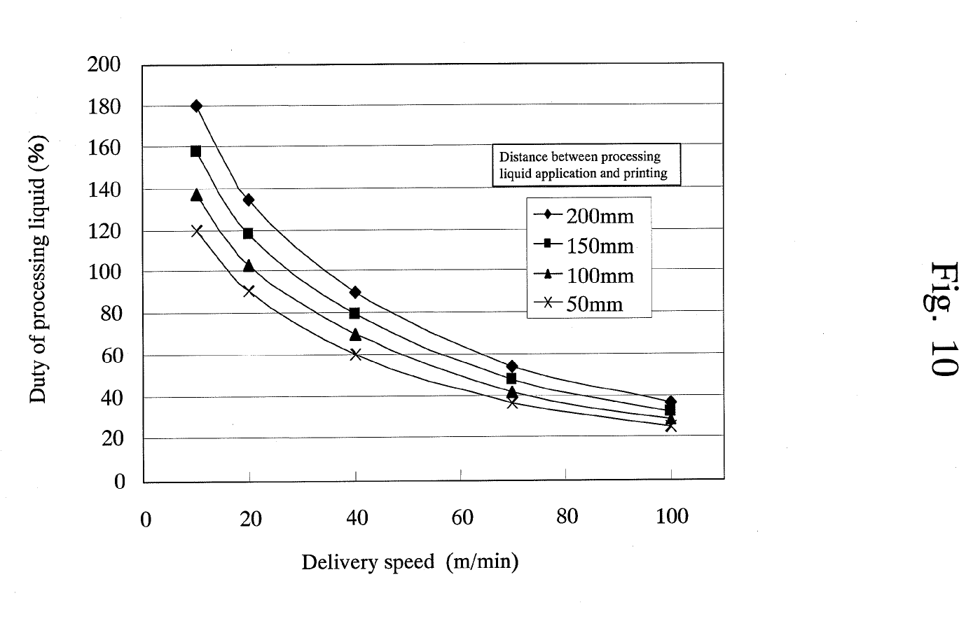

FIG. 8 is a graph showing the application amount of the processing liquid corresponding to the delivery speed of the recording medium in application of the processing liquid by means of a liquid sprayer. FIG. 9 is a graph showing the duty of the processing liquid depending on the delivery speed of the recording medium for printing at the resolution of 600 dpi of the processing liquid applicator and printing head. FIG. 10 is a graph showing the duty of the processing liquid depending on the delivery speed of the recording medium for printing at the resolution of 300 dpi of the processing liquid applicator and printing head. The graph of FIG. 8 is prepared based on the data of Table 1; the graph of FIG. 9 is prepared based on the data of Table 2; and the graph of FIG. 10 is prepared based on the data of Table 3. In FIGS. 8-10 and Tables 1-3, the term “distance between processing liquid application and printing” signifies the distance between the processing liquid applicator 31 (FIG. 1, etc.) and the printing head 21 (FIG. 1, etc).

As shown in FIG. 8, with the longer “distance between the processing liquid application and the printing” and the lower delivery speed, the time between the application of the processing liquid and the impact of the ink droplets thereon is longer, and the processing liquid applied to the recording medium P can infiltrate readily entirely into the recording medium. Therefore, the longer the distance between the processing liquid application and the printing and the lower the delivery speed, the larger can the amount of the processing liquid be.

As shown in FIG. 9, with the longer “distance between the processing liquid application and the printing” and the lower delivery speed, the time between the application of the processing liquid and impact of the ink droplets thereon is longer, and the processing liquid applied to the recording medium P can infiltrate readily entirely into the recording medium. Therefore, the longer the distance between the processing liquid application and the printing and the lower the delivery speed, the larger can the duty on ejection of the processing liquid be made. In this case, when the delivery speed is low, the applied processing liquid can overlap to give the duty higher than 100%. In the example shown in FIG. 9, the resolution of the processing liquid applicator and the printing head is 600 dpi. In this case, the amount of the processing liquid can be increased for the same delivery speed in comparison with the case of low resolution (e.g., 300 dpi in FIG. 10).

As shown in FIG. 10, with the longer “distance between the processing liquid application and the printing” and the lower delivery speed, the time between the application of the processing liquid and impact of the ink droplets thereon is longer, and the processing liquid applied to the recording medium P can infiltrate readily entirely into the recording medium. Therefore, the longer the distance between the processing liquid application and printing and the lower the delivery speed, the larger can the duty on ejection of the processing liquid be made. In this case, when the delivery speed is low, the applied processing liquid can spread and overlap with each other to give the duty higher than 100%. In the example of FIG. 10, the resolution of the processing liquid applicator and the printing head is 300 dpi. In this case, the amount of the processing liquid is decreased for the same delivery speed in comparison with the case of high resolution (e.g., 600 dpi in FIG. 9).

In the above examples, the printer 10 has a processing liquid applicator 31 and four printing heads arranged in the direction of the recording medium delivery (arrow-A direction in FIG. 1, etc.). The present invention can be employed in other printers different in the number or arrangement of the processing liquid applicator or the printing heads.

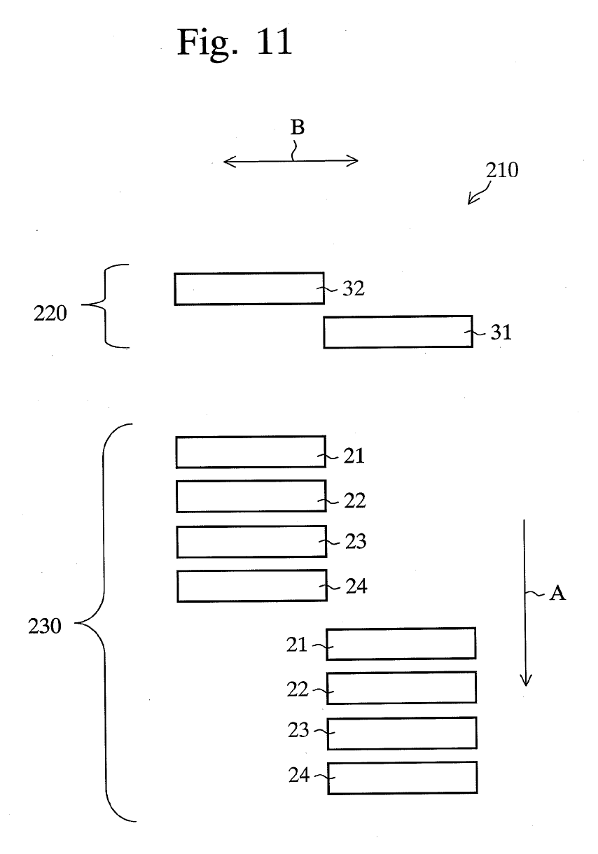

Other examples are explained in which the number or arrangement of the processing liquid applicator or the printing heads is different from the above example, by reference to FIGS. 11-13.

FIG. 11 is a plan view illustrating schematically another example different in the number and arrangement of the processing liquid applicators and the printing head.

In FIG. 11, the printer 210 has a processing liquid applicator unit 220 for applying uniformly the processing liquid on a wide recording medium, and a printing head unit 230 for ejecting ink onto an image formation region (a portion where an image is formed) of the recording medium. The processing liquid applicator unit 220 has processing liquid applicators 31,32 which are shifted slightly from each other in the recording medium delivery direction (arrow-A direction) with the long sides perpendicular to the delivery direction (paper sheet width direction, arrow-B direction).

Printing heads 21,22,23,24 are provided corresponding to the above processing liquid applicator 31, in FIG. 11, on the right half portion of the recording medium sheet in the width direction (arrow-B direction), and ink is ejected from the printing heads 21,22,23,24 onto the portion of the recording medium where the processing liquid has been applied by the processing liquid applicator 31. Similarly, printing heads 21,22,23,24 are provided corresponding to the above processing liquid applicator 32, in FIG. 11, on the left half portion of the recording medium sheet in the width direction (arrow-B direction), and ink is ejected from the printing heads 21,22,23,24 onto the portion of the recording medium on which the processing liquid has been applied by the processing liquid applicator 32. The use of two processing liquid applicators 31,32 and two sets of printing heads 21,22,23,24 enables formation of high-quality of image on a wide recording medium sheet.

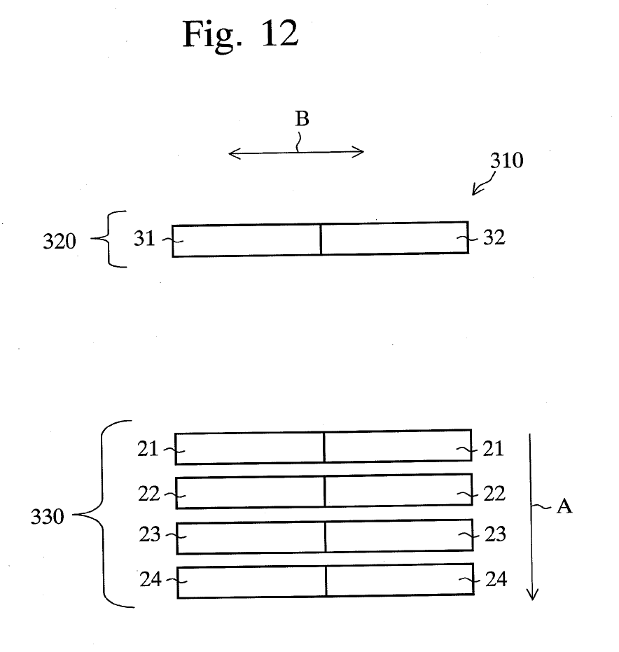

FIG. 12 is a plan view illustrating schematically still another example different in the number and arrangement of the processing liquid and the printing heads.

In FIG. 12, the printer 310 has a processing liquid applicator unit 320 for applying uniformly the processing liquid on a wide recording medium, and a printing head unit 330 for ejecting ink onto an image formation region (a portion where an image is to be formed) of the recording medium. The processing liquid applicator unit 320 has processing liquid applicators 31,32 which are arranged in the paper sheet width direction (arrow-B direction).

Printing heads 21,22,23,24 corresponding to the above processing liquid applicator 31 are provided, in FIG. 12, on the left half portion of the recording medium sheet in the width direction (arrow-B direction), and ink is ejected from the printing heads 21,22,23,24 onto the portion of the recording medium on which the processing liquid has been applied by the processing liquid applicator 31. Similarly, printing heads 21,22,23,24 corresponding to the above processing liquid applicator 32 are provided, in FIG. 12, on the right half portion of the recording medium sheet in the width direction (arrow-B direction), and ink is ejected from the printing heads 21,22,23,24 onto the portion of the recording medium on which the processing liquid has been applied by the processing liquid applicator 32. The use of two processing liquid applicators 31,32 and two sets of printing heads 21,22,23,24 enables formation of a high-quality image on a wide recording medium sheet.

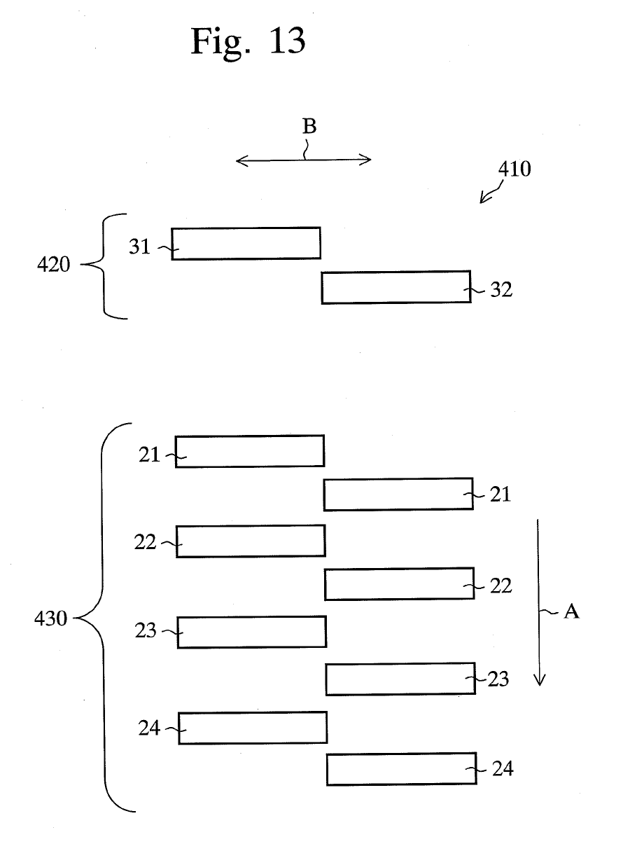

FIG. 13 is a plan view illustrating schematically still another example different in the number and arrangement of the processing liquid and the printing heads.

In FIG. 13, the printer 410 has a processing liquid applicator unit 420 for applying uniformly the processing liquid on a wide recording medium, and a printing head unit 430 for ejecting ink onto an image formation region (a portion where an image is to be formed) of the recording medium. The processing liquid applicator unit 420 has processing liquid applicators 31,32 which are shifted slightly from each other in the recording medium delivery direction (arrow-A direction) and directed paper sheet width direction (arrow-B direction). The processing liquid applicator 31 is placed, in FIG. 13, on the left half portion in the recording medium sheet width direction, whereas the processing liquid applicator 32 is shifted to a slightly downstream side of the processing liquid applicator 31 on the right half portion in the recording medium sheet width direction.

Printing heads 21,22,23,24 corresponding to the above processing liquid applicator 31 are provided, in FIG. 13, on the left half portion of the recording medium sheet in the width direction (arrow-B direction), and ink is ejected from the printing heads 21,22,23,24 onto the portion of the recording medium on which the processing liquid has been applied by the processing liquid applicator 31. Similarly, printing heads 21,22,23,24 corresponding to the above processing liquid applicator 32 are provided, in FIG. 13, on the right half portion of the recording medium sheet in the width direction (arrow-B direction), and ink is ejected from the printing heads 21,22,23,24 onto the portion of the recording medium on which the processing liquid has been applied by the processing liquid applicator 32. The use of two processing liquid applicators 31,32 and two sets of printing heads 21,22,23,24 enables formation of a high-quality image on a wide recording medium sheet.

As described above, according to the present invention, the amount of application of the processing liquid is decreased when the recording medium delivery speed is high, whereas the amount of application of the processing liquid is increased when the recording medium delivery speed is low, whereby the processing liquid is allowed to infiltrate entirely into the recording medium before the ink impacts the recording medium. Thus, since an image is formed by ejection of ink from the printing head onto the recording medium which contains a processing liquid having entirely infiltrated therein, the non-spread dotting phenomenon can be prevented which will be caused by imperfect infiltration of the processing liquid.

TABLE 1
AMOUNT OF APPLICATION (g/m²)

| Distance between | Delivery speed (m/min) | | | | |
|---|---|---|---|---|---|
| processing and printing | 10 | 20 | 40 | 70 | 100 |
| 200 mm | 21.2 | 15.9 | 10.6 | 6.36 | 4.24 |
| 150 mm | 18.55 | 13.886 | 9.328 | 5.618 | 3.71 |
| 100 mm | 16.218 | 12.19 | 8.162 | 4.876 | 3.286 |
| 50 mm | 14.098 | 10.706 | 7.102 | 4.24 | 2.862 |

The applicator was a sprayer

TABLE 2
DUTY (%) OF PROCESSING LIQUID

| Distance between | Delivery speed (m/min) | | | | |
|---|---|---|---|---|---|
| processing and printing 600 dpi | 10 | 20 | 40 | 70 | 100 |
| 200 mm | 200 | 150 | 100 | 60 | 40 |
| 150 mm | 175 | 131 | 88 | 53 | 35 |
| 100 mm | 153 | 115 | 77 | 46 | 31 |
| 50 mm | 133 | 101 | 67 | 40 | 27 |

The processing being conducted at 600 dpi
The printing being conducted at 600 dpi

TABLE 3
DUTY (%) OF PROCESSING LIQUID

| Distance between | Delivery speed (m/min) | | | | |
|---|---|---|---|---|---|
| processing and printing 300 dpi | 10 | 20 | 40 | 70 | 100 |
| 200 mm | 180 | 135 | 90 | 54 | 36 |
| 150 mm | 157.5 | 117.9 | 79.2 | 47.7 | 31.5 |
| 100 mm | 137.7 | 103.5 | 69.3 | 41.4 | 27.9 |
| 50 mm | 119.7 | 90.9 | 60.3 | 36 | 24.3 |

The processing being conducted at 300 dpi
The printing being conducted at 300 dpi

1. An image-forming apparatus having a processing liquid applicator for applying a processing liquid onto a recording medium under delivery in a delivery direction, and a printing head for ejecting ink onto the recording medium on which processing liquid has been applied by the processing liquid applicator: the apparatus comprising a controlling means for controlling the amount of the processing liquid to be applied to the recording medium being delivered depending on the delivery speed of the recording medium in the delivery direction.

2. The image-forming apparatus according to claim 1, wherein the controlling means controls the amount of the processing liquid to allow the processing liquid to infiltrate entirely into the recording medium before the ink is ejected from the printing head onto the portion of the recording medium on which the processing liquid has been applied by the processing liquid applicator.

3. The image-forming apparatus according to claim 1, wherein the controlling means serves to decrease the amount of the processing liquid for a high-speed delivery of the recording medium and to increase the amount of the processing liquid for a low speed delivery of the recording medium to allow the processing liquid to infiltrate entirely into the recording medium before the ink is ejected from the printing head onto the portion of the recording medium on which the processing liquid having been applied by the processing liquid applicator.

4. The image-forming apparatus according to claim 1, wherein the processing liquid applicator has plural nozzles which discharge respectively the processing liquid in accordance with an electric pulse,
and the controlling means controls the electric pulse to control the amount of the processing liquid ejected from the processing liquid applicator.

5. The image-forming apparatus according to claim 4, wherein the controlling means controls the amount of the processing liquid by selecting nozzle or nozzles out of the plural nozzles for ejecting the processing liquid.

6. The image-forming apparatus according to claim 1, wherein the processing liquid applicator has the same level of resolution as the printing head.

7. The image-forming apparatus according to claim 1, wherein the time interval is not more than 10 seconds between application of the processing liquid by the processing liquid applicator and ejection of the ink from the printing head onto the portion of the recording medium on which the processing liquid has been applied.

8. An image-forming method for forming an image by applying a processing liquid onto a recording medium under delivery in a delivery direction, and subsequently ejecting ink onto the recording medium on which the processing liquid has been applied, wherein the amount of the processing liquid to be applied to the recording medium under delivery is controlled depending on the delivery speed of the recording medium in the delivery direction.

9. The image-forming method according to claim 8, wherein the amount of the processing liquid is controlled so as to allow the processing liquid to infiltrate entirely into the recording medium before the ink is ejected onto the portion of the recording medium on which the processing liquid has been applied.

10. The image-forming method according to claim 8, wherein the amount of the processing liquid is decreased for a high-speed delivery of the recording medium and the amount of the processing liquid is increased for a low speed delivery of the recording medium to allow the processing liquid to infiltrate entirely into the recording medium before the ink is ejected from the printing head onto the portion of the recording medium on which the processing liquid has been applied.

11. The image-forming apparatus according to claim 2, wherein the controlling means serves to decrease the amount of the processing liquid for a high-speed delivery of the recording medium and to increase the amount of the processing liquid for a low speed delivery of the recording medium to allow the processing liquid to infiltrate entirely into the recording medium before the ink is ejected from the printing head onto the portion of the recording medium on which the processing liquid having been applied by the processing liquid applicator.

12. The image-forming apparatus according to claim 2, wherein the processing liquid applicator has plural nozzles which discharge respectively the processing liquid in accordance with an electric pulse,
and the controlling means controls the electric pulse to control the amount of the processing liquid ejected from the processing liquid applicator.

13. The image-forming apparatus according to claim 2, wherein the processing liquid applicator has the same level of resolution as the printing head.

14. The image-forming apparatus according to claim 3, wherein the processing liquid applicator has the same level of resolution as the printing head.

15. The image-forming apparatus according to claim 4, wherein the processing liquid applicator has the same level of resolution as the printing head.

16. The image-forming apparatus according to claim 5, wherein the processing liquid applicator has the same level of resolution as the printing head.

17. The image-forming apparatus according to claim 2, wherein the time interval is not more than 10 seconds between application of the processing liquid by the processing liquid applicator and ejection of the ink from the printing head onto the portion of the recording medium on which the processing liquid has been applied.

18. The image-forming apparatus according to claim 3, wherein the time interval is not more than 10 seconds between application of the processing liquid by the processing liquid applicator and ejection of the ink from the printing head onto the portion of the recording medium on which the processing liquid has been applied.

19. The image-forming apparatus according to claim 2, wherein the time interval is not more than 10 seconds between application of the processing liquid by the processing liquid applicator and ejection of the ink from the printing head onto the portion of the recording medium on which the processing liquid has been applied.

20. The image-forming apparatus according to claim 5, wherein the time interval is not more than 10 seconds between application of the processing liquid by the processing liquid applicator and ejection of the ink from the printing head onto the portion of the recording medium on which the processing liquid has been applied.

21. The image-forming apparatus according to claim 6, wherein the time interval is not more than 10 seconds between application of the processing liquid by the processing liquid applicator and ejection of the ink from the printing head onto the portion of the recording medium on which the processing liquid has been applied.

22. The image-forming method according to claim 9, wherein the amount of the processing liquid is decreased for a high-speed delivery of the recording medium and the amount of the processing liquid is increased for a low speed delivery of the recording medium to allow the processing liquid to infiltrate entirely into the recording medium before the ink is ejected from the printing head onto the portion of the recording medium on which the processing liquid has been applied.
